(19) United States
(12) Patent Application Publication
(10) Pub. No.: US 2014/0341187 A1
(43) Pub. Date: Nov. 20, 2014

(54) METHOD AND APPARATUS FOR TRAFFIC OFFLOADING

(71) Applicants: Yixue Lei, Beijing (CN); Kodo Shu, Beijing (CN)

(72) Inventors: Yixue Lei, Beijing (CN); Kodo Shu, Beijing (CN)

(73) Assignee: Nokia Corporation, Espoo (FI)

(21) Appl. No.: 14/365,596

(22) PCT Filed: Dec. 23, 2011
(86) PCT No.: PCT/CN2011/084528

§ 371 Date: Jun. 13, 2014

(51) Int. Cl. H04W 36/22; H04W 76/02

(52) U.S. Cl. CPC H04W 36/22; H04W 76/022; H04W 88/08
USPC 370/331

(57) ABSTRACT

A method, apparatus and computer program product are provided to support traffic offloading in a manner that relies upon,a wireless access point having a co-located local gateway (L-GW), but that does not require each access point to have a co-located L-GW. In the context of a method, the traffic offloading capabilities of at least one other access point is initially determined. The method may also cause a tunnel to be established with another access point with a co-located L-GW having traffic offloading capabilities. Further, the method cause communications with a network to be conducted via the tunnel established with the another access point so as to utilize the traffic offloading capabilities of the another access point.

### TECHNOLOGICAL FIELD

An example embodiment of the present invention relates generally to communications technology and, more particularly, to a method, apparatus and computer program product for traffic offloading.

### BACKGROUND

In order to reduce the traffic transmitted via a cellular network, user equipment, such as mobile terminals, may utilize wireless access points, such as femtocells, home node Bs (HNBs), home evolved node Bs (HeNBs) or the like, to support communications with a local internet protocol (IP) network. In this regard, user equipment may identify one or more wireless access points and may then communicate with the local IP network via a wireless access point instead of via the cellular network, that is, the macrocells and the operator's core network; e.g., the evolved packet core (EPC). The use of a wireless access point may, for example, reduce the signaling and traffic demands placed upon the cellular network so as to, for example, conserve the bandwidth of the cellular network.

In order to support local Internet Protocol (IP) access (LIPA) to a core network, a wireless access point, such as an HNB or an HeNB, may include a co-located local gateway (L-GW). An example of an HeNB having a co-located L-GW is shown in FIG. 1. As illustrated, the user equipment (UE) 10 may be in communication with the HeNB 11 via a Uu interface 12. The HeNB may, in turn, be in communication with a serving gateway (SGW) 13 and a mobility management entity (MME) 14 via an S1-U interface 15 and an S1-MME interface 16, respectively. As shown, the MME and the SGW may also be in communication with one another via an S11 interface 17. The SGW may, in turn, communicate with a packet data network (PDN) gateway (GW) 18 via an S5 interface 19 and the PDN-GW may, in turn, communicate with the remainder of the core network via an SGi interface 20. As illustrated in FIG. 1, the LIPA user plane includes both the HeNB and a L-GW 21. The L-GW may be configured to communicate with the SGW via an S5 interface 22 and with the remainder of the local IP network via an SGi interface 23.

A large number of wireless access points have already been deployed and additional numbers of wireless access points are anticipated to be deployed hereinafter. In order to support LIPA with the local IP network, the wireless access points may include or otherwise be co-located with an L-GW 21 which, in turn, has an S5 interface 22 with the SGW 13, as shown in FIG. 1. The number of S5 interfaces with the SGW may therefore be substantial, which may create an undesirably heavy load on the core network, for example. Additionally, the inclusion of a L-GW with each of the wireless access points may increase the cost of the wireless access points, which may slow the deployment of wireless access points having co-located L-GWs and, in turn, slow the support for traffic offloading to the wireless access points, for example.

In contrast to wireless access points having a co-located L-GW, a separate and distinct L-GW, that may be called a standalone L-GW, has been proposed in order to support LIPA with the local IP network on behalf of one or more wireless access points. The inclusion of a standalone L-GW may, for example, increase the complexity and costs of a wireless access system. As another example, a standalone L-GW may unfortunately require the development of a new interface between the wireless access points and the L-GW. A standalone L-GW may, for example, also increase the system architecture changes and standardization efforts in the third generation partnership project (3GPP).

### BRIEF SUMMARY

A method, apparatus and computer program product are therefore provided in order to support traffic offloading in a manner that relies upon a wireless access point having a co-located L-GW, but that does not require each access point to have a co-located L-GW. As such, the method, apparatus and computer program product of an example embodiment may enjoy the benefits associated with traffic offloading by, for example, reducing the signaling load and conserving the bandwidth of the cellular network, while reducing the costs otherwise incurred if each access point has a co-located L-GW. Moreover, the method, apparatus and computer program of an example embodiment may utilize existing interfaces with some enhancement in order to support the traffic offloading, thereby avoiding the development of a new interface.

In one embodiment, a method is provided that includes determining traffic offloading capabilities of at least one other access point. For example, the method may determine the traffic offloading capabilities by receiving an indication from a network entity or from the another access point regarding the traffic offloading capabilities of the another access point. The method of this embodiment may also cause a tunnel to be established with another access point with a co-located L-GW having traffic offloading capabilities. Further, the method may include causing communications with a network to be conducted via the tunnel established with the another access point so as to utilize the traffic offloading capabilities of the another access point. For example, communications may be caused to be conducted via the tunnel with a direct interface between the access points or by proxying the communications that are conducted via the tunnel with an interface proxied by a gateway.

In another embodiment, an apparatus is provided that includes at least one processor and at least one memory storing computer program code with the at least one memory and the computer program code configured to, with the processor, cause the apparatus to determine the traffic offloading capabilities of at least one other access point, such as by receiving an indication from a network entity or from the another access point regarding the traffic offloading capabilities of the another access point. The at least one memory and the computer program code may also be configured to, with the processor, cause the apparatus to cause a tunnel to be established with another access point with a co-located L-GW having traffic offloading capabilities. Further, the at least one memory and the computer program code may also be configured to, with the processor, cause the apparatus to cause communications with a network to be conducted via the tunnel established with the another access point so as to utilize the traffic offloading capabilities of the another access point. For example, communications may be caused to be conducted via the tunnel with a direct interface between the access points or by proxying the communications that are conducted via the tunnel with an interface proxied by a gateway.

In a further embodiment, a computer program product is provided that includes at least one computer-readable storage medium having computer-executable program code portions stored therein with the computer-executable program code portions including program instructions configured to determine traffic offloading capabilities of at least one other access point. For example, the program instructions may be configured to determine the traffic offloading capabilities by receiving an indication from a network entity or from the another access point regarding the traffic offloading capabilities of the another access point. The computer-executable program code portions may also include program instructions configured to cause a tunnel to be established with another access point with a co-located L-GW having traffic offloading capabilities. Further, the computer-executable program code portions may include program instructions configured to cause communications with a network to be conducted via the tunnel established with the another access point so as to utilize the traffic offloading capabilities of the another access point. For example, communications may be caused to be conducted via the tunnel with a direct interface between the access points or by proxying the communications that are conducted via the tunnel with an interface proxied by a gateway.

In yet another embodiment, an apparatus is provided that includes means for determining traffic offloading capabilities of at least one other access point. The apparatus of this embodiment may also include means for causing a tunnel to be established with another access point with a co-located L-GW having traffic offloading capabilities. Further, the apparatus may include means for causing communications with a network to be conducted via the tunnel established with the another access point so as to utilize the traffic offloading capabilities of the another access point.

In one embodiment, a method is provided that includes causing an indication of traffic offloading capabilities of an access point with a co-located L-GW to be provided, such as to a network entity, such as a support node, or to another access point. The method of this embodiment may also include causing a tunnel to be established with another access point without traffic offloading capabilities. The method may also support communications between the another access point without traffic offloading capabilities and a network via the tunnel established with the another access point. For example, the method may support communications between the another access point and the network by causing communications to be conducted via the tunnel with a direct interface between the access points or by proxying the communications that are conducted via the tunnel with an interface proxied by a gateway.

In another embodiment an apparatus is provided that includes at least one processor and at least one memory storing computer program code with the at least one memory and the computer program code configured to, with the processor, cause the apparatus to at least cause an indication of traffic offloading capabilities of an access point with a co-located L-GW to be provided, such as to a network entity, such as a support node, or to another access point. The at least one memory and the computer program code may also be configured to, with the processor, cause the apparatus to cause a tunnel to be established with another access point without traffic offloading capabilities. In this embodiment, the at least one memory and the computer program code may also be configured to, with the processor, cause the apparatus to support communications between the another access point without traffic offloading capabilities and a network via the tunnel established with the another access point. For example, the at least one memory and the computer program code may also be configured to, with the processor, cause the apparatus to support communications between the another access point and the network by causing communications to be conducted via the tunnel with a direct interface between the access points or by proxying the communications that are conducted via the tunnel with an interface proxied by a gateway.

In a further embodiment, a computer program product is provided that includes at least one computer-readable storage medium having computer-executable program code portions stored therein with the computer-executable program code portions including program instructions configured to cause an indication of traffic offloading capabilities of an access point with a co-located L-GW to be provided, such as to a network entity, such as a support node, or to another access point. The computer-executable program code portions of this embodiment also include program instructions configured to cause a tunnel to be established with another access point without traffic offloading capabilities. The computer-executable program code portions may also include program instructions configured to support communications between the another access point without traffic offloading capabilities and a network via the tunnel established with the another access point. For example, the program instructions may be configured to support communications between the another access point and the network by causing communications to be conducted via the tunnel with a direct interface between the access points or by proxying the communications that are conducted via the tunnel with an interface proxied by a gateway.

In yet another embodiment, an apparatus is provided that includes means for causing an indication of traffic offloading capabilities of an access point with a co-located L-GW to be provided, such as to a network entity, such as a support node, or to another access point. The apparatus of this embodiment may also include means for causing a tunnel to be established with another access point without traffic offloading capabilities. The apparatus may also include means for supporting communications between the another access point without traffic offloading capabilities and a network via the tunnel established with the another access point. For example, the means for supporting communications between the another access point and the network may include means for causing communications to be conducted via the tunnel with a direct interface between the access points or means for proxying the communications that are conducted via the tunnel with an interface proxied by a gateway.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 is an example block diagram of the LIPA architecture for a HeNB having a co-located L-GW;

FIG. 2 is a schematic representation of a system in accordance with an example embodiment of the present invention;

FIG. 3 is a block diagram of an apparatus that may be embodied by or associated with an access point and configured in accordance with an example embodiment of the present invention;

FIG. 4 is a flowchart illustrating the operations performed in order to offload traffic to another access point having a co-located L-GW in accordance with an example embodiment of the present invention;

FIG. 5 is a signaling flow diagram depicting the manner in which the traffic offloading capabilities are shared in accordance with an example embodiment of the present invention;

FIG. 6 is a signaling flow diagram depicting the manner in which the traffic offloading capabilities are shared in accordance with another example embodiment of the present invention;

FIG. 7 is an example illustration of a user plane interface between an access point that is offloading traffic and another access point having a co-located L-GW;

FIG. 8 is a representation of a control plane interface between an access point that is offloading traffic and another access point having a co-located L-GW in accordance with an example embodiment of the present invention; and

FIG. 9 is a flowchart of the operations performed by an access point having a co-located L-GW in accordance with an example embodiment of the present invention.

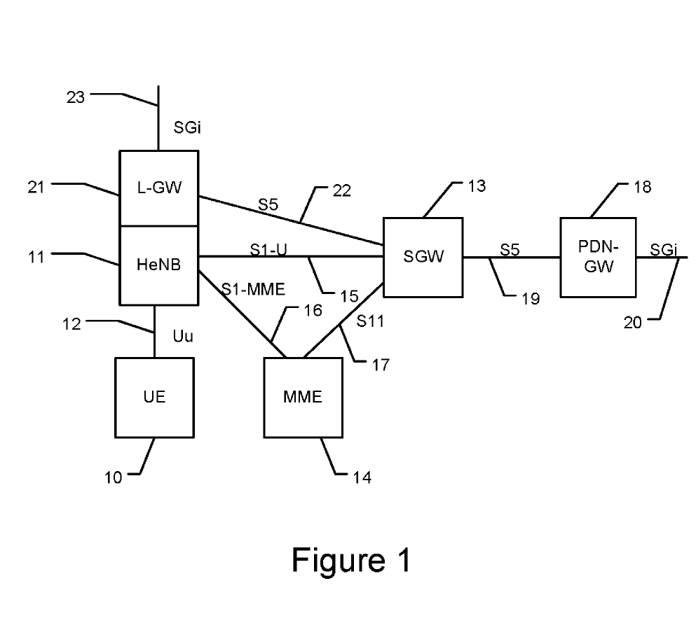

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

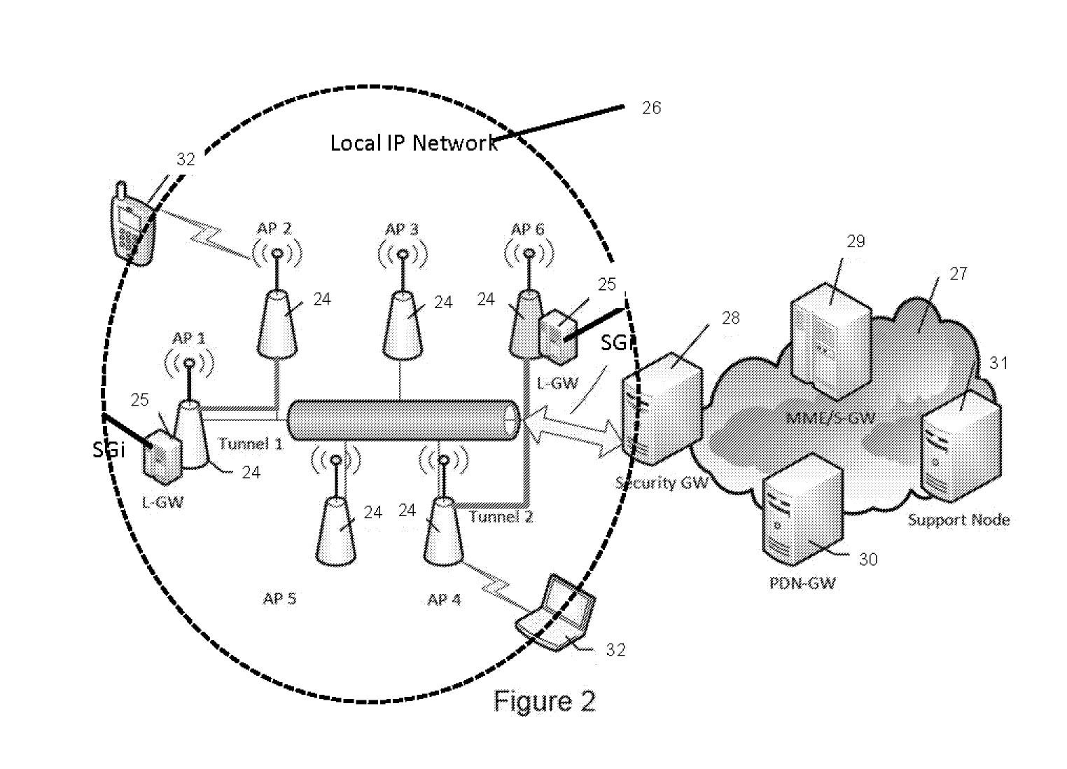

Referring now to FIG. 2, a schematic representation of a system in accordance with an example embodiment of the present invention is illustrated. As shown, the system includes a plurality of wireless access points 24, such as HNBs, HeNBs, local area network access points or the like. At least one of the access points includes a co-located L-GW 25 that may, for example, terminate an evolved packet system (EPS) bearer and may provide an interface, such as a SGi interface, to a local IP network 26. In the example depicted in FIG. 2, access points AP1 and AP6 include co-located L-GWs. Additionally, at least one of the access points does not include a co-located L-GW, such as access points AP2, AP3, AP4 and AP5 in the example embodiment of FIG. 2. By having access points that do not include a co-located L-GW, the cost of the access points may be reduced relative to access points having a co-located L-GW. However, the access points that do not include a co-located L-GW may not have LIPA capability to access the local IP network.

In this regard, FIG. 2 also includes a schematic representation of a local IP network 26. The local IP network may, in turn, communication with a core network 27. As shown, the core network may include a security gateway 28, an MME/SGW 29 and a PDN-GW 30. As described below, the core network may also include other network entities, such as a support node 31 in some embodiments. As also shown in FIG. 2, user equipment 32, such as mobile terminals may be in communication with a respective access point 24. The user equipment may be embodied as a mobile terminal such as a portable digital assistant (PDA), a mobile telephone, a pager, a mobile television, a gaming device, a laptop computer, a camera, a tablet computer, a touch surface, a wearable device, a video recorder, an audio/video player, a radio, an electronic book, a positioning device (e.g., a global positioning system (GPS) device), or any combination of the aforementioned, and other types of voice and text communications systems. However, the user equipment may also be embodied in a variety of other devices, both mobile and fixed, and therefore embodiments of the present invention should not be limited to application on mobile terminals. With respect to the example embodiment of FIG. 2, a cellular telephone is shown to be in communication with access point AP2 and a laptop computer is shown to be in communication with access point AP4.

In instances, such as shown in FIG. 2, in which the user equipment 32 is in communication with an access point 24 that does not include a co-located L-GW 25, traffic, such as IP traffic, offloaded from a cellular network by the user equipment to the access point cannot directly be communicated to the local IP network 26 since the access points do not support LIPA. In this regard, the user plane data path for a conventional access point that does not include a co-located L-GW may be much longer and may flow, from the user equipment 32, to the access point to an optional access point gateway to the SGW 28 to the PDN-GW 30 to the internet and finally to the local IP network.

In accordance with an example embodiment of the present invention, however, a tunnel may be established between the access point 24 that is in communication with the user equipment 32 but that does not include a co-located L-GW and an access point that does include a co-located L-GW 25. In the example of FIG. 2, a tunnel may be established between access point AP4 that is in communication with a laptop computer, but that does not include a co-located L-GW and access point AP6 that does include a co-located L-GW. Similarly, a tunnel may be established between access point AP2 that is in communication with the mobile terminal, but that does not include a co-located L-GW and access point AP1 that does include a co-located L-GW.

In this regard, traffic between the user equipment 32 to the access point 24 that does not include a co-located L-GW 25 may be communicated in a secure manner via a tunnel to another access point that does include a co-located L-GW such that the other access point having the co-located L-GW can, in turn, communicate with the local IP network 26. In this regard, the user plane data path for an access point that includes a co-located L-GW may be more direct with the data path flowing from the user equipment, to the access point, to the co-located L-GW and then to the local IP network. By leveraging the traffic offloading capabilities of the access points having a co-located L-GW, the access points that do not include a co-located L-GW can support traffic offloading, but the overall costs associated with the access points and the number, of interfaces, such as S5 interfaces between the access points and the core network, may be reduced.

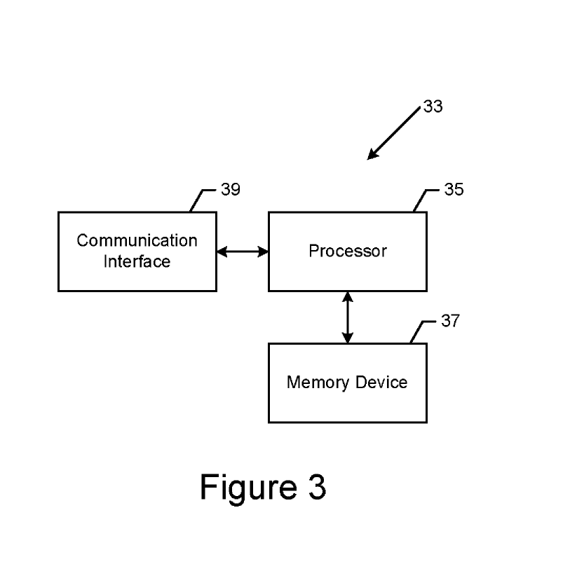

An apparatus 33 that may be embodied by or associated with an access point 24 and that may be configured to perform the various operations described herein with respect to the access points may be depicted as shown in FIG. 3. In this regard, the apparatus may include or otherwise be in communication with a processor 35, a memory device 37 and a communication interface 39. In some embodiments, the processor (and/or co-processors or any other processing circuitry assisting or otherwise associated with the processor) may be in communication with the memory device via a bus for passing information among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

While the apparatus 33 may be embodied by an access point that is configured to employ an example embodiment of the present invention. However, in some embodiments, the apparatus or at least components of the apparatus, such as the processor 35, may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 35 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 35 may be configured to execute instructions stored in the memory device 37 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., an access point 24) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

Meanwhile, the communication interface 39 may be any means such as a device or circuitry embodied in either hardware or a combination of hardware and software that is configured to receive and/or transmit data from/to a local IP network 26 and/or any other device or module in communication with the apparatus 33, such as another access point 24 or the user equipment 32. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

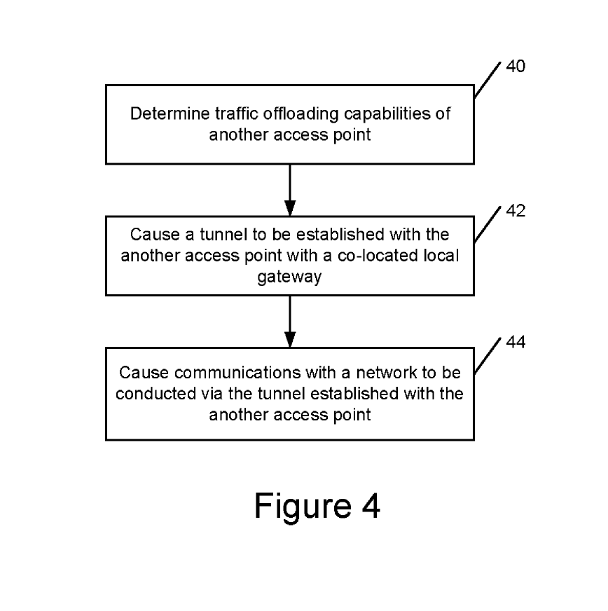

The operations performed by the method, apparatus 33 and computer program product of an example embodiment of the present invention are shown in FIG. 4. In this regard, the apparatus embodied by an access point 24 that does not include a co-located L-GW 25 may include means, such as the processor 35, the communications interface 39 or the like, for initially determining the traffic offloading capabilities of at least one other access point. See block 40 of FIG. 4. For example, the apparatus, such as a processor, the communication interface or the like, embodied by an access point that does not include a co-located L-GW may determine the traffic offloading capabilities of an access point that does include a co-located L-GW. In this regard, the apparatus, such as the processor, the communication interface or the like, embodied by an access point that does not include a co-located L-GW may determine the traffic offloading capabilities of other access points that are proximate thereto, such as access points within the same local area network that are located sufficiently close together such that wireless communications may be conducted directly between the access points.

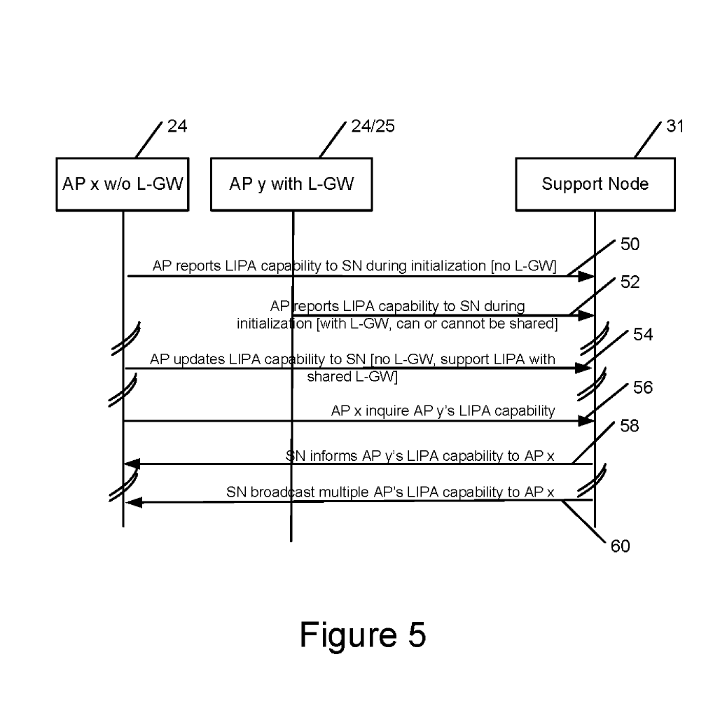

The traffic offloading capabilities of the access points 24 may be determined in various manners. In one embodiment shown in FIG. 5, for example, each access point may report its traffic offloading capabilities, such as an indication of whether the access point has a co-located L-GW that may be shared as well as its LIPA capabilities, to a network entity, such as a support node 31, during the initialization of the respective access points. As shown, in FIG. 5, an access point, such as AP x, that does not include a co-located L-GW 25 and an access point, such as AP y, that does include a co-located L-GW, may report its traffic offloading capabilities to the support node during initialization. See signaling messages 50 and 52, respectively. The traffic offloading capabilities that are reported to the support node may not only include an indication as to whether or not the access point includes a co-located L-GW, but in an instance in which the access point does include a co-located L-GW, the traffic offloading capabilities reported by the respective access point may also include an indication as to whether or not the co-located L-GW may be shared with other access points as well as an indication as to whether or not LIPA is supported.

Although the access points 24 may provide indications of their traffic offloading capabilities in various manners, the access points may provide signaling messages to the support node 31 that include an information element (IE) that indicates the traffic offloading capabilities, such as the LIPA capabilities, of the respective access point during initialization of the access point. For example, the signaling message that includes the IE that, in turn, includes an indication of the traffic offloading capabilities of the respective access point may be an S1 setup request in a Long Term Evolution (LTE)/LTE-Advanced (LTE-A) system.

As also illustrated by signaling message 54 in FIG. 5, an access point 24 may provide an update to its traffic offloading capabilities, such as its LIPA capabilities, to a network entity, such as a support node 31. For example, an access point, such as AP x, that does not include a co-located L-GW 25 may provide an update to the support node indicating that the access point does not include a co-located L-GW, but also providing an indication that the access point desirably supports traffic offloading by utilizing a L-GW that is co-located with another access point. In one embodiment, an access point may provide an evolved Node B (eNB) Configuration Update message to inform the support node about its traffic offloading capability if such capability is changed after the initialization.

In one embodiment, in response to a request by a user equipment 32 for traffic offloading, an access point 24 that does not include a co-located L-GW 25, such as AP x, may issue a request to the network entity, such as the support node 31, for an indication of one or more access points in proximity thereto as well as a traffic offloading capabilities, such as LIPA capabilities, of these other access points including an indication of which, if any, of the other access points includes a co-located L-GW that may be shared. See signaling message 56 of FIG. 5. The network entity, such as the support node, may then broadcast an indication of one or more access points in proximity to the access point that made the request along with the traffic offloading capabilities of the other access points including an indication of the other access points, if any, that have a co-located L-GW that may be shared. See signaling message 60. Alternatively and as also shown by signaling message 58 in FIG. 5, the support node need not broadcast an indication of the traffic offloading capabilities of one or more access points, but may, instead, provide an indication to the access point, e.g., AP x, that made the request of the traffic offloading capabilities, e.g., LIPA capabilities, of one or more access points, such as AP y, that have a co-located L-GW.

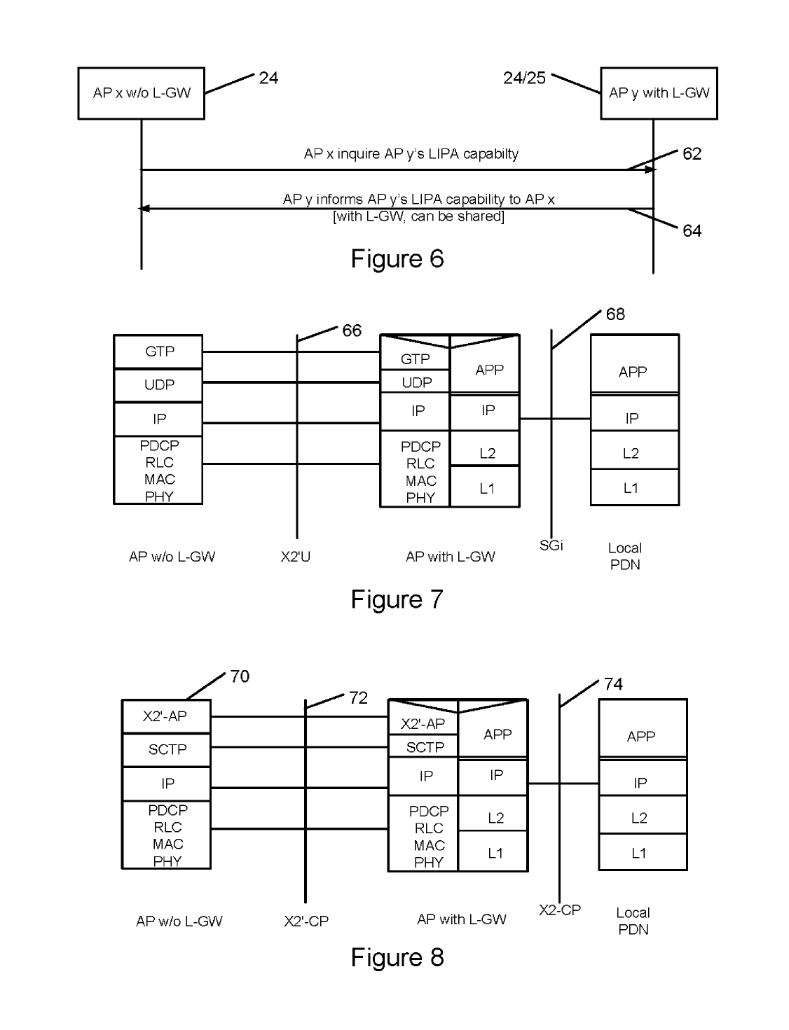

Although the access points 24 may communicate with a network entity, such as a support node 31, in order to determine the traffic offloading capabilities of the other access points, the access points may communicate directly with one another in other embodiments as shown in FIG. 6 in order to determine the traffic offloading capabilities of the other access points. In this regard, an access point that does not include a co-located L-GW 25, such as AP x, may communicate with another access, point in order to inquire regarding the traffic offloading capabilities, such as the LIPA capabilities, of the other access point. See signaling message 62 of FIG. 6. The other access point, such as AP y, may, in turn, respond to the access point that does not include a co-located L-GW and may provide an indication as to whether the other access point has a co-located L-GW and, if so, whether the co-located L-GW can be shared. See signaling message 64. While the signaling messages between the access points as shown in FIG. 6 may be provided in various manners, the signaling messages between the access points may be provided via an eNB Configuration Update message in X2 interface that includes an IE that may include an indication of the traffic offloading capabilities:

Regardless of the manner in which the traffic offloading capabilities of the access points 24 are shared, the access point that includes a co-located L-GW 25 that may be shared may be identified to the access point that does not include a co-located L-GW by means of an identifier. While various types of identifiers may be utilized, the access point having a co-located L-GW that may be shared may be identified, in one embodiment, by an eNB global identifier or a cell identifier in combination with local IP address of the co-located L-GW.

In an instance in which the user equipment 32 is desirous of offloading traffic, such as IP traffic, the access point 24 that is in communication with the user equipment may not include a co-located L-GW 25, but may have determined that another access point does include a co-located L-GW that may be shared, as described above. The apparatus 33 of one embodiment may therefore include means, such as the processor 35, the communications interface 39 or the like, for causing a tunnel to be established between the access points, such as Tunnel 1 between access points AP1 and AP2 and Tunnel 2 between access points AP4 and AP6 in the example embodiment of FIG. 2. See block 42 of FIG. 4. The tunnel may be established between the access points in various manners.

In one embodiment, the apparatus 33, such as the processor 35, the communication interface 39 or the like, may cause a tunnel to be established between access points 24 by utilizing the X2 interface. The X2 interface that is established between the access point that is desirous of traffic offloading but that does not include a co-located L-GW 25 and the access point that does include a co-located L-GW that may be shared may be a direct X2 interface between the access points or may be proxied with an interface being proxied by an X2 gateway. In either instance, the user plane and control plane protocol stacks for an X2 interface of one example embodiment between an access point that does not include a co-located L-GW 25 and an access point that does include a co-located L-GW are depicted in FIGS. 7 and 8. With respect to the user plane interface of FIG. 7, an enhanced X2′-U interface 66 may be utilized to allow user traffic to be delivered with the tunnel established between the access point without the co-located L-GW and the access point with the co-located L-GW. As shown in FIG. 7, the access point with the co-located L-GW may also utilize an SGi interface 68 to communicate with the PDN-GW 30. In regards to the control plane interface of FIG. 8, however, the control plane interface may be enhanced by inclusion of an X2′-AP layer 70 that may be included in the control plane protocol stack to identify the enhanced X2 Application Protocol entity. The control plane protocol stack may be provided by an access point without a co-located L-GW to an access point with a co-located L-GW via an X2′-CP interface 72 and, in turn, from the access point with the co-located L-GW to the PDN-GW via an X2-CP interface 74. In order to establish the tunnel, the endpoints of the tunnel, such as the access points may be identified, such as by a general packet radio service (GPRS) Tunneling Protocol—User (GTP-U) tunneling endpoint identifier (TEID) that may either be reused for traffic offloading or be newly assigned to support traffic offloading.

In order to cause the establishment of a tunnel between the access point 24 that is desirous of traffic offloading but that does not include a co-located L-GW 25 and another access point that does include a co-located L-GW that may be shared, the apparatus 33 embodied by an access point may include means, such as the processor 35, the communication interface 39 or the like, for determining if an X2 interface exists between the access points. If so, the apparatus, such as the processor, the communication interface or the like, may be determine if the X2 interface is suitable for traffic offloading, e.g., LIPA sharing. If so, traffic, such as IP traffic, may be offloaded utilizing the X2 interface between the access points. If not, traffic offloading is terminated since the X2 interface is not suitable. In an instance in which an X2 interface does not already exist, the apparatus may include means, such as the processor, the communication interface or the like, for triggering the establishment of an X2 interface for supporting traffic offloading. The X2 interface may be established with a cause value, such as offloading capability sharing. In this regard, the access point without a co-located L-GW may send an X2 setup request to the access point with a co-located L-GW with offloading capability sharing as the cause value with the access point with a co-located L-GW then determining whether to accept the request.

As shown in block 44 of FIG. 4, once the tunnel has been established, the apparatus 33 embodied by the access point 24 that does not include a co-located L-GW 25 may include means, such as a processor 35, the communications interface 39 or the like, for causing communications with the local IP network 26 to be conducted via the tunnel. In this regard, the access point that does not include a co-located L-GW may offload traffic, such as IP traffic, to the access point that does include a co-located L-GW via the tunnel with the access point that does include a co-located L-GW then communicating with the local IP network on behalf of the access point that does not include a co-located L-GW.

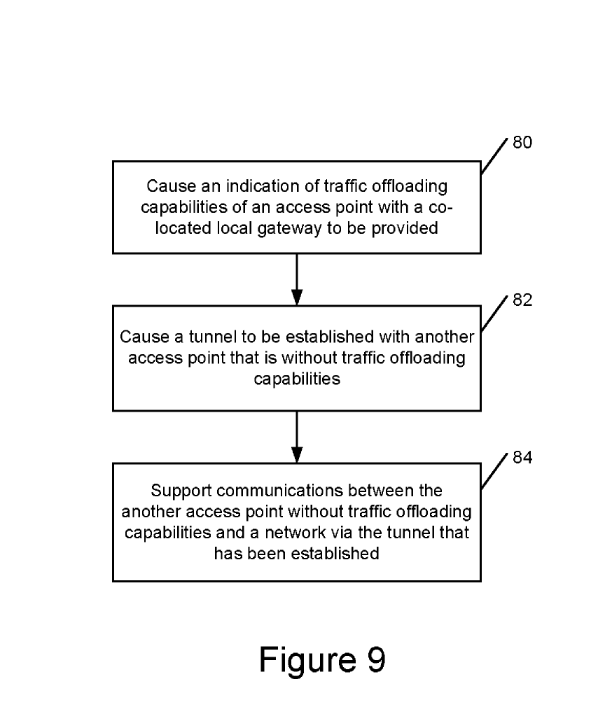

From the perspective of the access point 24, such as access points AP1 and AP6 in FIG. 2, that does include a co-located L-GW 25 that may be shared with another access point that does include a co-located L-GW, the apparatus 33 embodied by the access point that includes a co-located L-GW that may be shared may include means, such as the processor 35, the communications interface 39 or the like, for causing an indication of the traffic offloading capabilities of the access point to be provided. See block 80 of FIG. 9. As described above in conjunction with FIGS. 5 and 6, the apparatus, such as the processor, the communication interface or the like, embodied by access point that includes a co-located L-GW may provide an indication to a network entity, such as a support node 31, that indicates that the access point has a co-located L-GW and that may also indicate whether or not the co-located L-GW can be shared. Alternatively, the indication regarding the availability of a co-located L-GW for sharing may be provided directly to another access point, such as in response to a request from the other access point.

As shown in block 82 of FIG. 9, the apparatus 33 embodied by the access point 24 that includes a co-located L-GW 25 may also include means, such as the processor 35, the communications interface 3 or like, for causing a tunnel to be established with another access point that does not have traffic offloading capabilities, e.g., does not have LIPA capabilities. As also described above, the tunnel may be established utilizing, for example, an X2 interface. Once the tunnel has been established, the apparatus embodied by the access point that includes a co-located L-GW may also include means, such as the processor, the communications interface or the like, for supporting communications between the other access point that does not include traffic offloading capabilities, that is, does not include a co-located L-GW, and a network, such as the local IP network 26, via the tunnel established between the access points. See block 84 of FIG. 9.

As such, the system of an example embodiment of the present invention may, for example, support traffic offloading so as to reduce the load and/or conserve bandwidth of the cellular network. However, the system of an example embodiment may support offloading of IP traffic in a manner that does not require each access point 24 to have a co-located L-GW 25, thereby reducing the costs associated with one example of the system.

As described above, FIGS. 4 and 9 illustrate flowcharts of an apparatus, method, and computer program product according to example embodiments of the invention from the perspective of an apparatus 33 embodied by an access point 24. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture; the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
determining traffic offloading capabilities of at least one other access point;
causing a tunnel to be established with another access point with a co-located local gateway having traffic offloading capabilities; and
causing communications with a network to be conducted via the tunnel established with the another access point so as to utilize the traffic offloading capabilities of the another access point.

2. A method according to claim 1, wherein determining the traffic offloading capabilities comprises receiving an indication from a network entity regarding the traffic offloading capabilities of the another access point.

3. A method according to claim 1, wherein determining the traffic offloading capabilities comprises receiving an indication from the another access point regarding the traffic offloading capabilities of the another access point.

4. A method according to claim 1, wherein causing communications with the network comprises causing communications to be conducted via the tunnel with a direct interface between the access points.

5. A method according to claim 1, wherein causing communications with the network comprises proxying the communications that are conducted via the tunnel with an interface proxied by a gateway.

6. An apparatus comprising at least one processor and at least one memory storing computer program code, the at least one memory and the computer program code configured to, with the processor, cause the apparatus to at least:
determine traffic offloading capabilities of at least one other access point;
cause a tunnel to be established with another access point with a co-located local gateway having traffic offloading capabilities; and
cause communications with a network to be conducted via the tunnel established with the another access point so as to utilize the traffic offloading capabilities of the another access point.

7. An apparatus according to claim 6, wherein the at least one memory and the computer program code are configured to, with the processor, cause the apparatus to determine the traffic offloading capabilities by receiving an indication from a network entity regarding the traffic offloading capabilities of the another access point.

8. An apparatus according to claim 6, wherein the at least one memory and the computer program code are configured to, with the processor, cause the apparatus to determine the traffic offloading capabilities by receiving an indication from the another access point regarding the traffic offloading capabilities of the another access point.

9. An apparatus according to claim 6, wherein the at least one memory and the computer program code are configured to, with the processor, cause the apparatus to cause communications with the network by causing communications to be conducted via the tunnel with a direct interface between the access points.

10. An apparatus according to claim 6, wherein the at least one memory and the computer program code are configured to, with the processor, cause the apparatus to cause communications with the network by proxying the communications that are conducted via the tunnel with an interface proxied by a gateway.

11. A non-transitory computer program product comprising at least one computer-readable storage medium having computer-executable program code portions stored therein, the computer-executable program code portions comprising program instructions configured to:
determine traffic offloading capabilities of at least one other access point;
cause a tunnel to be established with another access point with a co-located local gateway having traffic offloading capabilities; and
cause communications with a network to be conducted via the tunnel established with the another access point so as to utilize the traffic offloading capabilities of the another access point.

12. A non-transitory computer program product according to claim 11 wherein the program instructions configured to determine the traffic offloading capabilities comprise program instructions configured to receive an indication from a network entity regarding the traffic offloading capabilities of the another access point.

13. A non-transitory computer program product according to claim 11, wherein the program instructions configured to determine the traffic offloading capabilities comprise program instructions configured to receive an indication from the another access point regarding the traffic offloading capabilities of the another access point.

14. A non-transitory computer program product according to claim 11, wherein the program instructions configured to cause communications with the network comprise program instructions configured to cause communications to be conducted via the tunnel with a direct interface between the access points.

15. A non-transitory computer program product according to claim 11, wherein the program instructions configured to cause communications with the network comprise program instructions configured to proxy the communications that are conducted via the tunnel with an interface proxied by a gateway.

16. (canceled)

17. (canceled)

18. (canceled)

19. (canceled)

20. (canceled)

21. A method comprising:
causing an indication of traffic offloading capabilities of an access point with a co-located local gateway to be provided;
causing a tunnel to be established with another access point without traffic offloading capabilities; and
supporting communications between the another access point without traffic offloading capabilities and a network via the tunnel established with the another access point.

22. A method according to claim 21, wherein causing an indication of traffic offloading capabilities comprises causing an indication of the traffic offloading capabilities to be provided to a network entity.

23. A method according to claim 21, wherein causing an indication of traffic offloading capabilities comprises causing an indication of the traffic offloading capabilities to be provided to the another access point.

24. A method according to claim 21, wherein supporting communications between the another access point and the network comprises causing communications to be conducted via the tunnel with a direct interface between the access points.

25. A method according to claim 21, wherein supporting communications between the another access point and the network comprises proxying the communications that are conducted via the tunnel with an interface proxied by a gateway.

26. An apparatus comprising at least one processor and at least one memory storing computer program code, the at least one memory and the computer program code configured to, with the processor, cause the apparatus to at least:
cause an indication of traffic offloading capabilities of an access point with a co-located local gateway to be provided;
cause a tunnel to be established with another access point with traffic offloading capabilities; and
support communications between the another access point with traffic offloading capabilities and a network via the tunnel established with the another access point.

27. An apparatus according to claim 26, wherein the at least one memory and the computer program code are configured to, with the processor, cause the apparatus to cause an indication of traffic offloading capabilities by causing an indication of the traffic offloading capabilities to be provided to a network entity.

28. An apparatus according to claim 26, wherein the at least one memory and the computer program code are configured to, with the processor, cause the apparatus to cause an indication of traffic offloading capabilities by causing an indication of the traffic offloading capabilities to be provided to the another access point.

29. An apparatus according to claim 26, wherein the at least one memory and the computer program code are configured to, with the processor, cause the apparatus to support communications with the network by causing communications to be conducted via the tunnel with a direct interface between the access points.

30. An apparatus according to claim 26, wherein the at least one memory and the computer program code are configured to, with the processor, cause the apparatus to support communications between the another access point and the network by proxying the communications that are conducted via the tunnel with an interface proxied by a gateway.

31. A non-transitory computer program product comprising at least one computer-readable storage medium having computer-executable program code portions stored therein, the computer-executable program code portions comprising program instructions configured to:
cause an indication of traffic offloading capabilities of an access point with a co-located local gateway to be provided;
cause a tunnel to be established with another access point without traffic offloading capabilities; and
support communications between the another access point without traffic offloading capabilities and a local IP network via the tunnel established with the another access point.

32. A non-transitory computer program product according to claim 31, wherein the program instructions configured to cause an indication of traffic offloading capabilities comprise program instructions configured to cause an indication of the traffic offloading capabilities to be provided to a network entity.

33. A non-transitory computer program product according to claim 31, wherein the program instructions configured to cause an indication of traffic offloading capabilities comprise program instructions configured to cause an indication of the traffic offloading capabilities to be provided to the another access point.

34. A non-transitory computer program product according to claim 31, wherein the program instructions configured to support communications with the network comprise program instructions configured to cause communications to be conducted via the tunnel with a direct interface between the access points.

35. A non-transitory computer program product according to claim 31, wherein the program instructions configured to support communications between the another access point and the network comprise program instructions configured to proxy the communications that are conducted via the tunnel with an interface proxied by a gateway.

36. (canceled)

37. (canceled)

38. (canceled)

39. (canceled)

40. (canceled)
